(19) United States
(12) Patent Application Publication
(10) Pub. No.: US 2023/0264405 A1
(43) Pub. Date: Aug. 24, 2023

(54) AUTOMATIC PRODUCTION LINE FOR CONDUCTIVE TAPE AND A MANUFACTURING METHOD FOR CONDUCTIVE TAPE

(71) Applicants: Qingjun ZHENG, Jiangshu (CN); Shanjun ZHANG, Jiangshu (CN); Shubin LIN, Jiangshu (CN)

(72) Inventors: Qingjun ZHENG, Jiangshu (CN); Shanjun ZHANG, Jiangshu (CN); Shubin LIN, Jiangshu (CN)

(21) Appl. No.: 17/991,845

(22) Filed: Nov. 22, 2022

(30) Foreign Application Priority Data
Feb. 22, 2022 (CN) 202210163413.6

(51) Int. Cl. B29C 48/154; B29C 48/07; B29C 48/92; B29C 48/88; B29C 48/00; H01B 13/00; H01B 13/14

(52) U.S. Cl. CPC B29C 48/154; B29C 48/07; B29C 48/92; B29C 48/9135; B29C 48/0023; H01B 13/0016; H01B 13/14; B29C 2948/92123; B29C 2948/92171; B29C 2948/92295; B29K 2995/0005; B29L 2031/3462

(57) ABSTRACT

The present invention relates to the technical field of wire-rod production equipment, in particular relates to an automatic production line for conductive tape and a manufacturing method for conductive tape, Automatic production of conductive tape brings about high production efficiency and low cost; it not only conducts pretreatment and corresponding detections of the conductors in the production process but also conducts follow-up treatment and corresponding detections of the conductive tape and thus improves the production quality of the conductive tape; in addition, it marks the abnormality position of the conductive tape which is abnormal during the withstand voltage detection so that the operator can accurately find out the abnormal section of the conductive tape.

### BACKGROUND OF THE INVENTION

The present invention relates to the technical field of wire-rod production equipment, more specifically relates to an automatic production line for conductive tape and a manufacturing method for conductive tape.

The conductive tape belongs to cables and is widely used in various fields, and the conductive tape mainly comprises a conductor and the encapsulating layer. With the development and progress of society, people have higher and higher requirements for the quality of conductive tape. In the prior art, the conductor is mainly coated by the encapsulating layer via the extruder to form the conductive tape. In the process of forming the conductive tape, there is no pretreatment and corresponding detections of the conductors as well as follow-up treatment and corresponding detections on the formed conductive tape; therefore, it is difficult to ensure the quality of the conductive tape and that there are potential safety hazards in the use of the conductive tape. Therefore, the prior art is with obvious defects and urgently needs a solution.

### BRIEF SUMMARY OF THE INVENTION

In order to solve the aforementioned technical problem, a purpose of the present invention is to provide an automatic production line for conductive tape and a manufacturing method for conductive tape.

In order to achieve the above purpose, the present invention provides the following technical solutions:

An automatic production line for conductive tape comprises a conductor releasing device, a conductor straightening device, a conductor pulling device, a flatness detecting device, an ultrasonic cleaning device, a conductor heating device, a encapsulating extruder, a diameter measuring gauge, a cooling device, a code spraying device, an ultrasonic wall thickness detecting device, a wire-rod pulling device, an appearance detecting device, a withstand voltage detecting device, an abnormality marking device, a meter calculating device, a drying device and a wire take-up device successively arranged in the processing direction of conductive tape; the said withstand voltage detecting device is electrically connected with the said abnormality marking device; the conductors released by the said conductor releasing device pass through the said conductor straightening device, the said conductor pulling device, the said flatness detecting device, the said ultrasonic cleaning device, the said conductor heating device, the said encapsulating extruder, the said diameter measuring gauge, the said cooling device, the said code spraying device, the said ultrasonic wall thickness detecting device, the said wire-rod pulling device, the said appearance detecting device, the said withstand voltage detecting device, the said abnormality marking device, the said meter calculating device and the drying device successively and then is wound up by the said wire take-up device; the said conductor straightening device is used for straightening the conductors; the said conductor pulling device is used for pulling the conductors to move; the flatness detecting device is used for detecting the flatness of the conductors; the said ultrasonic cleaning device is used for cleaning the conductors ultrasonically; the said conductor heating device is used for heating the conductors; the said encapsulating extruder is used for encapsulating the conductors to form the conductive tape; the said diameter measuring device is used for measuring the diameters of the conductors; the said cooling device is used for cooling the conductive tape; the said code spraying device is used for code-spraying the conductive tape; the said ultrasonic wall thickness detecting device is used for measuring the encapsulating thickness on the conductive tape; the said wire-rod pulling device is used for pulling the conductive tape to move; the said appearance detecting device is used for detecting the appearance quality of the conductive tape; the withstand voltage detecting device is used for detecting the withstand voltage of the conductive tape; the abnormality marking device is used for marking the conductive tape which is abnormal upon the withstand voltage test; the meter calculating device is used for calculating the length of the conductive tape and the said drying device is used for drying the conductive tape.

Further, the said automatic production line for conductive tape also comprises a trimming mechanism for trimming the conductive tape, the said trimming mechanism is located between the said drying device and the said wire take-up device, and the said trimming mechanism is electrically connected with the said meter calculating device.

Further, the said conductor straightening device comprises a straightening table as well as a number of first guide roller sets, a longitudinal straightening mechanism and a transverse straightening mechanism successively arranged on the said straightening table, wherein the said longitudinal straightening mechanism comprises two rows of longitudinal straightening wheel sets, and each row of the longitudinal straightening wheel sets comprises a plurality of longitudinal straightening wheels arranged in a straight line, and a plurality of longitudinal straightening wheels among the two rows of longitudinal straightening wheel sets are staggered up and down at intervals; the said transverse straightening mechanism comprises two rows of transverse straightening wheel sets, and the two rows of horizontal straightening wheel sets comprise a plurality of transverse straightening wheels arranged in a straight line, and a plurality of transverse straightening wheels among the two rows of transverse straightening wheel sets are staggered left and right at intervals.

Further, the said flatness detecting device comprises a flatness detecting table as well as a transverse flatness detecting mechanism and a longitudinal flatness detecting mechanism respectively arranged on the said flatness detecting table, wherein the said transverse flatness detecting mechanism is perpendicular to the said longitudinal flatness detecting mechanism and arranged in the processing direction of the conductive tape.

Further, the said transverse flatness detecting mechanism comprises two oppositely arranged transverse flatness detecting assemblies, a first mobile base which is slidably arranged on the said flatness detecting table and a first mobile driving mechanism which is arranged on the said flatness detecting table and is used for driving the said first mobile base to move transversely, wherein the two transverse flatness detecting assemblies are connected with the said first mobile base.

Further, the said longitudinal flatness detecting mechanism comprises two oppositely arranged longitudinal flatness detecting assemblies, a second mobile base which is slidably arranged on the said flatness detecting table and a second mobile driving mechanism which is arranged on the said flatness detecting table and is used for driving the said second mobile base to move transversely, wherein the two longitudinal flatness detecting assemblies are connected with the said second mobile base.

Further, the said flatness detecting device also comprises an air-blowing dust remover and a second guide roller set respectively arranged on the flatness detecting table, wherein the said air-blowing dust remover is located on one side at the discharge end of the conductor pulling device and the said second guide roller set is located on one side at the feed end of the said ultrasonic cleaning device.

Further, the said air-blowing dust remover is provided with a passage slot in the axial direction, and the said air-blowing dust remover is provided with several air-blowing passages in the radial direction leading to the passage slot.

Further, the said abnormality marking device comprises a base body, two guide assemblies, an upper lifting base, a lower lifting base, an upper indenting wheel, a lower indenting wheel, two marking pens and a marking drive mechanism, wherein the said upper indenting wheel is arranged oppositely to the said lower indenting wheel; both the said upper lifting base and the lower lifting base are arranged in the base body; the said marking drive mechanism is used for driving the upper lifting base and the lower lifting base to approach or leave each other; the said marking pens are arranged on the upper lifting base and the lower lifting base respectively.

The present invention also provides a manufacturing method for conductive tape comprising the following steps:

A. The said conductor releasing device releases the conductors;

B. The said conduct pulling device pulls the conductors to move;

C. The said conduct straightening device straightens the moving conductors;

D. The flatness detecting device detects the flatness of the straightened conductors;

E. The said ultrasonic cleaning device cleans the flatness-tested conductors ultrasonically;

F. The said conductor heating device heats the ultrasonically cleaned conductors;

G. The encapsulating extruder encapsulates the heated conductors to form the conductive tape and the wire-rod pulling device pulls the conductive tape to move;

H. When the conductive tape is moving, the said diameter measuring gauge measures the diameter of the conductive tape, the said cooling device cools the conductive tape, the said code spraying device performs the code spraying treatment of the conductive tape, the said ultrasonic wall thickness detecting device measures the encapsulation thickness of the conductive tape, the said appearance detecting device detects the appearance quality of the conductive tape, the said withstand voltage detecting device detects the withstand voltage of the conductive tape, the said abnormality marking device marks the conductive tape which is abnormal upon the withstand voltage test, the said meter measuring device calculates the length of the conductive tape and the said drying device dries the conductive tape.

I. The said wire take-up device winds up the conductive tape.

The present invention has the beneficial effects that: the automatic production line for conductive tape and the manufacturing method for conductive tape can perform automatic production of conductive tape, improving the production efficiency, relieving the labor intensity and lowering the labor cost; it not only conducts pretreatment and corresponding detections of the conductors in the production process but also conducts follow-up treatment and corresponding detections of the conductive tape, and thus avails the production monitoring of the conductive tape and greatly improves the production quality of the conductive tape; in addition, it uses the abnormality marking device to mark the abnormality position of the conductive tape which is abnormal during the withstand voltage detection so that the operator can accurately find out the abnormal section of the conductive tape and prevent any inferior conductive tape from being mixed with qualified conductive tape.

### BRIEF DESCRIPTION OF THE DRAWINGS

FIG. 1 is a structural schematic diagram of the present invention.

FIG. 2 is a top view of the transverse straightening mechanism of the present invention.

FIG. 3 is a front view of the longitudinal straightening mechanism of the present invention.

FIG. 4 is a front view of the flatness detecting device of the present invention.

FIG. 5 is a side view of the flatness detecting device of the present invention.

FIG. 6 is a front view of the abnormality marking device of the present invention.

### DESCRIPTION OF MARKS IN THE ABOVE FIGURES

1—conductor releasing device; 2—conductor straightening device; 3—conductor pulling device; 4—flatness detecting device; 5—ultrasonic cleaning device; 6—conductor heating device; 7—encapsulating extruder; 8—diameter measuring gauge; 9—cooling device; 10—code spraying device; 11—ultrasonic wall thickness detecting device; 12—wire-rod pulling device; 13—appearance detecting device; 14—withstand voltage detecting device; 15—abnormality marking device; 16—meter measuring device; 17—drying device; 18—wire take-up device; 19—trimming mechanism; 20—straightening table; 21—first guide roller set; 22—longitudinal straightening mechanism; 23—transverse straightening mechanism; 24—longitudinal straightening wheel set; 25—transverse straightening wheel set; 26—flatness detecting table; 27—transverse flatness detecting mechanism; 28—longitudinal flatness detecting mechanism; 29—transverse flatness detecting assembly; 30—first mobile base; 31—first mobile driving mechanism; 32—longitudinal flatness detecting assembly; 33—second mobile base; 34—second mobile driving mechanism; 35—air-blowing dust remover; 36—second guide roller set; 37—passage slot; 38—air-blowing passage; 39—base body; 40—guide assembly; 41—upper lifting base; 42—lower lifting base; 43—upper indenting wheel; 44—lower indenting wheel; 45—marking pen; 46—marking drive mechanism.

### DETAILED DESCRIPTION OF THE INVENTION

In order to facilitate the understanding of those skilled in the art, the present invention will be further described in combination with the embodiments and the accompanying drawings; the described embodiments are merely a part of the present invention.

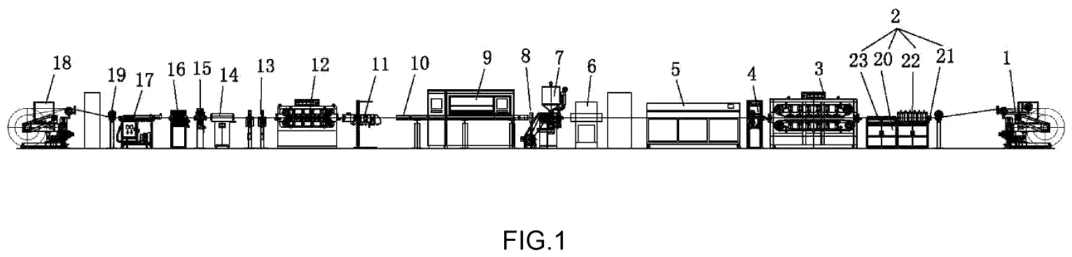

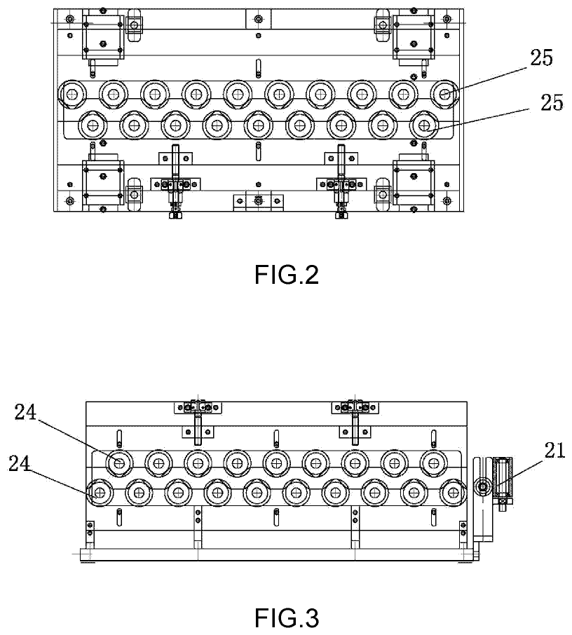

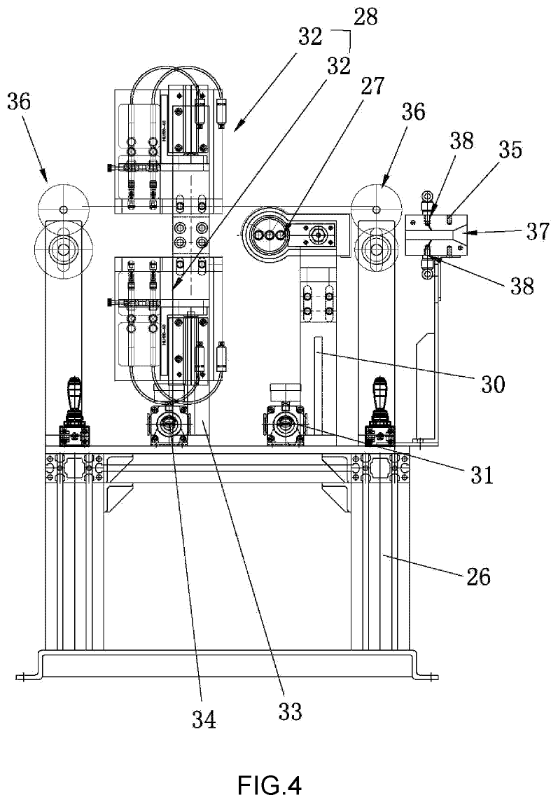

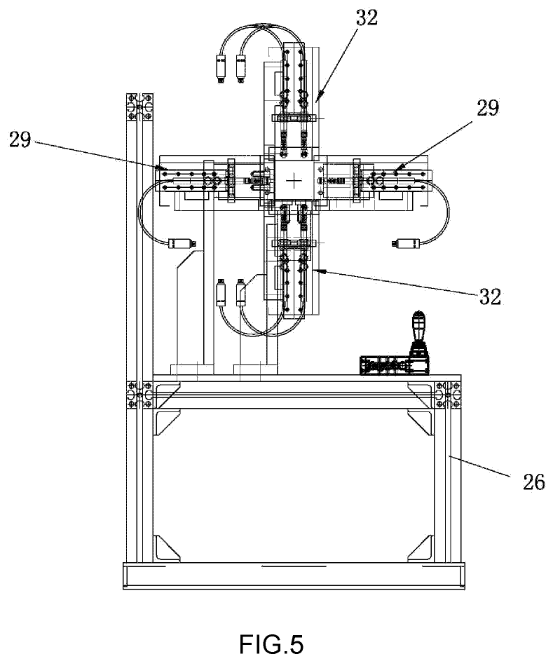

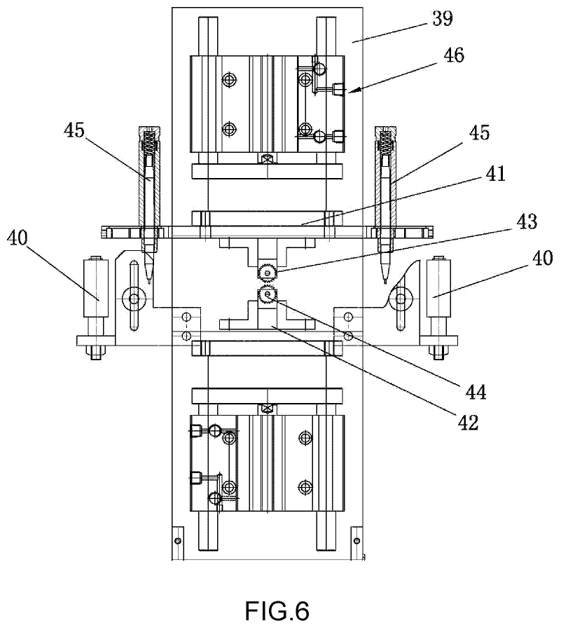

As shown from FIG. 1 to FIG. 6, the present invention provides an automatic production line for conductive tape comprising a conductor releasing device (1), a conductor straightening device (2), a conductor pulling device (3), a flatness detecting device (4), an ultrasonic cleaning device (5), a conductor heating device (6), a encapsulating extruder (7), a diameter measuring gauge (8), a cooling device (9), a code spraying device (10), an ultrasonic wall thickness detecting device (11), a wire-rod pulling device (12), an appearance detecting device (13), a withstand voltage detecting device (14), an abnormality marking device (15), a meter calculating device (16), a drying device (17) and a wire take-up device (18) successively arranged in the processing direction of conductive tape; the said withstand voltage detecting device (14) is electrically connected with the said abnormality marking device (15); the conductors released by the said conductor releasing device (1) pass through the said conductor straightening device (2), the said conductor pulling device (3), the said flatness detecting device (4), the said ultrasonic cleaning device (5), the said conductor heating device (6), the said encapsulating extruder (7), the said diameter measuring gauge (8), the said cooling device (9), the said code spraying device (10), the said ultrasonic wall thickness detecting device (11), the said wire-rod pulling device (12), the said appearance detecting device (13), the said withstand voltage detecting device (14), the said abnormality marking device (15), the said meter calculating device (16) and the drying device (17) successively and then is wound up by the said wire take-up device (18); the said conductor straightening device (2) is used for straightening the conductors; the said conductor pulling device (3) is used for pulling the conductors to move; the flatness detecting device (4) is used for detecting the flatness of the conductors; the said ultrasonic cleaning device (5) is used for cleaning the conductors ultrasonically; the said conductor heating device (6) is used for heating the conductors and reducing the temperature difference between the conductors and the encapsulating material; the said encapsulating extruder (7) is used for encapsulating the conductors to form the conductive tape; the said diameter measuring device (8) is used for measuring the diameters of the conductors; the said cooling device (9) is used for cooling the conductive tape; the said code spraying device (10) is used for code-spraying the conductive tape; the said ultrasonic wall thickness detecting device (11) is used for measuring the encapsulating thickness on the conductive tape; the said wire-rod pulling device (12) is used for pulling the conductive tape to move; the said appearance detecting device (13) is used for detecting the appearance quality of the conductive tape; the withstand voltage detecting device (14) is used for detecting the withstand voltage of the conductive tape; the abnormality marking device (15) is used for marking the conductive tape which is abnormal upon the withstand voltage test; the meter calculating device (16) is used for calculating the length of the conductive tape and the said drying device (17) is used for drying the conductive tape; preferably, the conductive tape can be made from flat wires. The automatic production line for conductive tape can perform automatic production of conductive tape, improving the production efficiency, relieving the labor intensity and lowering the labor cost; it not only conducts pretreatment and corresponding detections of the conductors in the production process but also conducts follow-up treatment and corresponding detections of the conductive tape, and thus avails the production monitoring of the conductive tape and greatly improves the production quality of the conductive tape; in addition, it uses the abnormality marking device to mark the abnormality position of the conductive tape which is abnormal during the withstand voltage detection so that the operator can accurately find out the abnormal section of the conductive tape and prevent any inferior conductive tape from being mixed with qualified conductive tape.

In this embodiment, the said automatic production line for conductive tape also comprises a trimming mechanism (19) for trimming the conductive tape, the said trimming mechanism (19) is located between the said drying device (17) and the said wire take-up device (18), and both the wire take-up device (18) and the said trimming mechanism (19) are electrically connected with the said meter calculating device (16). The meter measuring device (16) can calculate the length of the conductive tape; when the length of the conductive tape wound up by the wire take-up device (18) reaches the preset value, the wire take-up device (18) will stop winding up the conductive tape and the trimming mechanism (19) will trim the conductive tape; after that, the operator can remove the wire wheel fully wound with the conductive tape and then wind up the conductive tape with another empty wire wheel.

In this embodiment, the said conductor straightening device (2) comprises a straightening table (20) as well as a number of first guide roller sets (21), a longitudinal straightening mechanism (22) and a transverse straightening mechanism (23) successively arranged on the said straightening table (20), wherein the straightening clearance of the said longitudinal straightening mechanism (22) corresponds to the straightening clearance of the said transverse straightening mechanism (23); the said longitudinal straightening mechanism (22) comprises two rows of longitudinal straightening wheel sets (24), and each row of the longitudinal straightening wheel sets (24) comprises a plurality of longitudinal straightening wheels arranged in a straight line, and a plurality of longitudinal straightening wheels among the two rows of longitudinal straightening wheel sets (24) are staggered up and down at intervals; the said transverse straightening mechanism (23) comprises two rows of transverse straightening wheel sets (25), and the two rows of horizontal straightening wheel sets (25) comprise a plurality of transverse straightening wheels arranged in a straight line, and a plurality of transverse straightening wheels among the two rows of transverse straightening wheel sets (25) are staggered left and right at intervals; preferably, the number of the first guide roller sets is two groups, the said longitudinal straightening mechanism (22) and the said transverse straightening mechanism (23) are located in front of the two groups of first guide roller sets (21), the said first guide roller set comprises a longitudinal guide roller and a transverse guide roller, and the longitudinal guide and the transverse guide roller are arranged in a vertical and staggered manner.

In practical applications, as the conductors are wound for a long time, the released conductors will take on certain curvature; therefore, it is necessary to use the conductor straightening device (2) to straighten the conductors before encapsulating the conductors. Concretely, the moving conductors successively pass through one group of first guide roller sets (21), the longitudinal straightening mechanism (22), the transverse straightening mechanism (23) and the other group of first guide roller sets (21); the two rows of longitudinal straightening wheel sets (24) on the longitudinal straightening mechanism (22) roll, press and straighten the upper and lower sides of the conductors; the two rows of transverse straightening wheel sets on the transverse straightening mechanism (23) roll, press and straighten the left and right sides of the conductors; a plurality of longitudinal straightening wheels of the two rows of the longitudinal straightening wheel sets are staggered up and down at intervals and thus make the conductors swing up and down in the process of moving; a plurality of transverse straightening wheels of the two rows of the transverse straightening wheel sets are staggered left and right at intervals and thus make the conductors swing left and right in the process of moving; after that, the conductors straightened longitudinally and transversely will become straight, helping to improve the concentricity of the conductors and the encapsulating layer and thus improve the quality of the conductive tape.

In this embodiment, the said flatness detecting device (4) comprises a flatness detecting table (26) as well as a transverse flatness detecting mechanism (27) and a longitudinal flatness detecting mechanism (28) respectively arranged on the said flatness detecting table (26), wherein the said transverse flatness detecting mechanism (27) is perpendicular to the said longitudinal flatness detecting mechanism (28) and arranged in the processing direction of the conductive tape.

In practical applications, the transverse flatness detecting mechanism (27) detects the flatness of the left and right sides of the conductors (such as flat conductors); the longitudinal flatness detecting mechanism (28) detects the flatness of the upper and lower sides of the conductors, detects and monitors the flatness of the conductors online in real time in order to ensure that the conductors can meet the flatness requirements before being encapsulated and thus improve the production quality of the conductive tape.

In this embodiment, the said transverse flatness detecting mechanism (27) comprises two oppositely arranged transverse flatness detecting assemblies (29), a first mobile base (30) which is slidably arranged on the said flatness detecting table (26) and a first mobile driving mechanism (31) which is arranged on the said flatness detecting table (26) and is used for driving the said first mobile base (30) to move transversely, wherein the two transverse flatness detecting assemblies (29) are connected with the said first mobile base (30). Concretely, the said transverse flatness detecting assembly (29) comprises a transverse driver arranged on the first mobile base (30), a transverse connecting plate arranged on the transverse driver and a transverse flatness detector arranged on the transverse connecting plate; the said transverse driver can be an air cylinder and the said transverse flatness detector can be a flatness detector or a laser displacement sensor, etc.

In practical applications, the two groups of transverse flatness detecting assemblies (29) detect the flatness of the left and rear sides of the conductor respectively; concretely, the transverse driver drives the transverse connecting plate to move together with the transverse flatness detector to make the transverse flatness detector approach or leave the sides of the conductors and thus not only avail the flatness detection of the conductors but also avail the fatness detection of the conductors with different specifications and sizes. When it is necessary to adjust the transverse position of the two groups of transverse flatness detecting assemblies (29) or perform the reciprocating detection on the side flatness of the conductors in an online manner, the first mobile driving mechanism (31) will drive the first mobile base (30) to move, the moving first mobile base (30) will drive the two groups of transverse flatness detecting assemblies (29) to move so as to realize the position adjustment and reciprocating movement of the transverse flatness detecting assemblies (29).

In this embodiment, the said longitudinal flatness detecting mechanism (28) comprises two oppositely arranged longitudinal flatness detecting assemblies (32), a second mobile base (33) which is slidably arranged on the said flatness detecting table (26) and a second mobile driving mechanism (34) which is arranged on the said flatness detecting table (26) and is used for driving the said second mobile base (33) to move transversely, wherein the two longitudinal flatness detecting assemblies (32) are connected with the said second mobile base (33). Concretely, the said longitudinal flatness detecting assembly (32) comprises a longitudinal driver arranged on the second mobile base (33), a longitudinal connecting plate arranged on the longitudinal driver and a longitudinal flatness detector arranged on the longitudinal connecting plate; the said longitudinal driver can be an air cylinder and the said longitudinal flatness detector can be a flatness detector or a laser displacement sensor, etc.

In practical applications, the two groups of longitudinal flatness detecting assemblies (32) detect the flatness of the upper and lower sides of the conductor respectively; concretely, the longitudinal driver drives the longitudinal connecting plate to move together with the longitudinal flatness detector to make the longitudinal flatness detector approach or leave the sides of the conductors and thus not only avail the flatness detection of the conductors but also avail the fatness detection of the conductors with different specifications and sizes. When it is necessary to adjust the longitudinal position of the two groups of longitudinal flatness detecting assemblies (32) or perform the reciprocating detection on the side flatness of the conductors in an online manner, the second mobile driving mechanism (34) will drive the second mobile base (33) to move, the moving second mobile base (33) will drive the two groups of longitudinal flatness detecting assemblies (32) to move so as to realize the position adjustment and reciprocating movement of the longitudinal flatness detecting assemblies (32).

In this embodiment, the said flatness detecting device (4) also comprises an air-blowing dust remover (35) and a second guide roller set (36) respectively arranged on the flatness detecting table (26), wherein the said air-blowing dust remover (35) is located on one side at the discharge end of the conductor pulling device (3) and the said second guide roller set (36) is located on one side at the feed end of the said ultrasonic cleaning device (5). before the conductor flatness detection, the air-blowing dust remover (35) blows air to the conductors in order to blow away the dust from the conductor surface and thus improve the accuracy of conductor flatness detection; the second guide roller set (36) guides and locates the conductors which have undergone the flatness detection and thus improves the movement stability and position accuracy of the conductors.

In this embodiment, the said air-blowing dust remover (35) is provided with a passage slot (37) in the axial direction, the said air-blowing dust remover (35) is provided with several air-blowing passages (38) in the radial direction leading to the passage slot (37), there is a plurality of air-blowing passages (38) and the air-blowing mechanism is connected with the air-blowing passages (38). The conductors pass through the passage slot; the air-blowing dust remover (35) blows air to the conductors in the passage slot (37) for dust-removing treatment, the passage slot (37) guides and locates the movement of the conductors and thus improves the movement stability and position accuracy of the conductors.

In this embodiment, the said abnormality marking device (15) comprises a base body (39), two guide assemblies (40), an upper lifting base (41), a lower lifting base (42), an upper indenting wheel (43), a lower indenting wheel (44), two marking pens (45) and a marking drive mechanism (46), wherein the said upper indenting wheel (43) is arranged oppositely to the said lower indenting wheel (44); both the said guide assemblies (40) are arranged in the base body (39); both the said upper lifting base (41) and the said lower lifting base (42) are arranged in the base body (39); the said upper indenting wheel (43) is rotationally connected with the upper lifting base (41) and the said lower indenting wheel (44) is rotationally connected with the lower lifting base (42); the said marking drive mechanism (46) is used for driving the upper lifting base (41) and the lower lifting base (42) to approach or leave each other; the said marking pens (45) are arranged on the upper lifting base (41) and the lower lifting base (42) respectively; concretely, the said marking drive mechanism (46) comprises two air cylinders, wherein the air cylinders are connected with the upper lifting base (41) and the lower lifting base (42) respectively; there are two guide assemblies (40), wherein the guide assemblies (40) are located at the positions before and after the marking respectively; movement guidance of the conductive tape via the guide assemblies (40) improves the move stability and position accuracy of the conductive tape and thus improves the quality and stability of conductive tape marking.

In real applications, the upper indenting wheel (43) and the lower indenting wheel (44) are in an open state; the conductive tape passes through the guide assemblies (40) and is located between the upper indenting wheel (43) and the lower indenting wheel (44); the guide assemblies (40) guide and locate the moving conductive tape and ensure the movement stability of the conductive tape; when it is necessary to mark the conductive tape, that is when the withstand voltage tester beaks down the conductive tape and then the conductive tape is abnormal partially, the marking drive mechanism (46) will drive the upper lifting base (41) and the lower lifting base (42) to approach or leave each other till the upper indenting wheel (43) and the lower indenting wheel (44) touch and squeeze the upper and lower sides of the conductive tape respectively; at the moment to make the marking pens (45) come into contact with the conductive tape; as the conductive tape moves, the upper indenting wheel (43) and the lower indenting wheel (44) will wavily come into contact with the conductive tape respectively and thus make indenting marks on the conductive tape, and meanwhile, the marking pens (45) will draw lines on the conductive tape and thus make the indenting and line-drawing marks on the conductive tape; the structure is simple with good working stability and can effectively make the indenting and line-drawing marks on the conductive tape, the obvious and clear marks enable the operators to find out the abnormal sections of the conductive tape easily and quickly.

Concretely, the said withstand voltage detecting device (14) can be a power-frequency electrical discharge machine; both the said conductor pulling device (3) and the wire-rod pulling device (12) can be crawler-type tractors; the said diameter measuring gauge (8) comprises a transverse caliper and a longitudinal caliper, wherein the transverse caliper measures the width of the conductive tape and the longitudinal caliper measures the thickness of the conductive tape.

Concretely, the said automatic production line for conductive tape also comprises an air blower for blowing air to the conductors, wherein the air blower is located between the said ultrasonic cleaning device (5) and the said conductor heating device (6). After the ultrasonic cleaning device (5) cleans the conductors ultrasonically, the air blower blows air to the conductors in order to dry the conductors, and the conductor heating device (6) heats the dried conductors.

The present invention also provides a manufacturing method for conductive tape comprising the following steps:

A. The said conductor releasing device (1) releases the conductors;

B. The said conduct pulling device (3) pulls the conductors to move;

C. The said conductor straightening device (2) straightens the moving conductors, ensuring the flatness of the conductors and availing the coaxiality of the conductors with the encapsulating layer;

D. The flatness detecting device (4) detects the flatness of the straightened conductors, detecting and monitoring online whether the flatness of the conductors meets follow-up encapsulation requirement;

E. The said ultrasonic cleaning device (5) cleans the flatness-tested conductors ultrasonically, ensuring the cleanliness of the conductors;

F. The said conductor heating device (6) heats the ultrasonically cleaned conductors, preheats the conductors before the encapsulation, reduces the temperature difference between the conductors and the encapsulating material, improves the quality of conductor encapsulation and thus improves the production quality of the conductors;

G. The encapsulating extruder (7) encapsulates the heated conductor to form the conductive tape and the wire-rod pulling device (12) pulls the conductive tape to move;

H. When the conductive tape is moving, the said diameter measuring gauge (8) measures and monitors the diameter of the conductive tape, the said cooling device (9) cools the conductive tape to improve the cooling efficiency of the conductive tape and avail the follow-up code spraying quality, the said code spraying device (10) performs the code spraying treatment of the conductive tape, the said ultrasonic wall thickness detecting device (11) measures the encapsulation thickness of the conductive tape, the said appearance detecting device (13) detects the appearance quality of the conductive tape, the said withstand voltage detecting device (14) detects the withstand voltage of the conductive tape, the said abnormality marking device (15) marks the conductive tape which is abnormal upon the withstand voltage test, the said meter measuring device (16) calculates the length of the conductive tape and the said drying device (17) dries the conductive tape.

I. The said wire take-up device (18) winds up the conductive tape.

The manufacturing method for conductive tape not only conducts pretreatment and corresponding detections of the conductors in the production process but also conducts follow-up treatment and corresponding detections of the conductive tape, and thus avails the production monitoring of the conductive tape and greatly improves the production quality of the conductive tape; in addition, it uses the abnormality marking device (15) to mark the abnormality position of the conductive tape which is abnormal during the withstand voltage detection so that the operator can accurately find out the abnormal section of the conductive tape and prevent any inferior conductive tape from being mixed with qualified conductive tape.

All the technical features in the embodiments can be freely combined in accordance with actual needs.

The aforementioned embodiments are preferable implementation schemes of the present invention; in addition, the present invention can also be implemented in other ways; any obvious substitution without departing from the concept of the technical scheme is within the protection scope of the invention.

What is claimed is:

1. An automatic production line for conductive tape, which is characterized in that it comprises a conductor releasing device, a conductor straightening device, a conductor pulling device, a flatness detecting device, an ultrasonic cleaning device, a conductor heating device, a encapsulating extruder, a diameter measuring gauge, a cooling device, a code spraying device, an ultrasonic wall thickness detecting device, a wire-rod pulling device, an appearance detecting device, a withstand voltage detecting device, an abnormality marking device, a meter calculating device, a drying device and a wire take-up device successively arranged in the processing direction of conductive tape; the said withstand voltage detecting device is electrically connected with the said abnormality marking device; the conductors released by the said conductor releasing device pass through the said conductor straightening device, the said conductor pulling device, the said flatness detecting device, the said ultrasonic cleaning device, the said conductor heating device, the said encapsulating extruder, the said diameter measuring gauge, the said cooling device, the said code spraying device, the said ultrasonic wall thickness detecting device, the said wire-rod pulling device, the said appearance detecting device, the said withstand voltage detecting device, the said abnormality marking device, the said meter calculating device and the drying device successively and then is wound up by the said wire take-up device; the said conductor straightening device is used for straightening the conductors; the said conductor pulling device is used for pulling the conductors to move; the flatness detecting device is used for detecting the flatness of the conductors; the said ultrasonic cleaning device is used for cleaning the conductors ultrasonically; the said conductor heating device is used for heating the conductors; the said encapsulating extruder is used for encapsulating the conductors to form the conductive tape; the said diameter measuring device is used for measuring the diameters of the conductors; the said cooling device is used for cooling the conductive tape; the said code spraying device is used for code-spraying the conductive tape; the said ultrasonic wall thickness detecting device is used for measuring the encapsulating thickness on the conductive tape; the said wire-rod pulling device is used for pulling the conductive tape to move; the said appearance detecting device is used for detecting the appearance quality of the conductive tape; the withstand voltage detecting device is used for detecting the withstand voltage of the conductive tape; the abnormality marking device is used for marking the conductive tape which is abnormal upon the withstand voltage test; the meter calculating device is used for calculating the length of the conductive tape and the said drying device is used for drying the conductive tape.

2. The automatic production line for conductive tape in accordance with claim 1, which is characterized in that the said automatic production line for conductive tape also comprises a trimming mechanism for trimming the conductive tape, the said trimming mechanism is located between the said drying device and the said wire take-up device, and the said trimming mechanism is electrically connected with the said meter calculating device.

3. The automatic production line for conductive tape in accordance with claim 1, which is characterized in that the said conductor straightening device comprises a straightening table as well as a number of first guide roller sets, a longitudinal straightening mechanism and a transverse straightening mechanism successively arranged on the said straightening table, wherein the said longitudinal straightening mechanism comprises two rows of longitudinal straightening wheel sets, and each row of the longitudinal straightening wheel sets comprises a plurality of longitudinal straightening wheels arranged in a straight line, and a plurality of longitudinal straightening wheels among the two rows of longitudinal straightening wheel sets are staggered up and down at intervals; the said transverse straightening mechanism comprises two rows of transverse straightening wheel sets, and the two rows of horizontal straightening wheel sets comprise a plurality of transverse straightening wheels arranged in a straight line, and a plurality of transverse straightening wheels among the two rows of transverse straightening wheel sets are staggered left and right at intervals.

4. The automatic production line for conductive tape in accordance with claim 1, which is characterized in that the said flatness detecting device comprises a flatness detecting table as well as a transverse flatness detecting mechanism and a longitudinal flatness detecting mechanism respectively arranged on the said flatness detecting table, wherein the said transverse flatness detecting mechanism is perpendicular to the said longitudinal flatness detecting mechanism and arranged in the processing direction of the conductive tape.

5. The automatic production line for conductive tape in accordance with claim 4, which is characterized in that the said transverse flatness detecting mechanism comprises two oppositely arranged transverse flatness detecting assemblies, a first mobile base which is slidably arranged on the said flatness detecting table and a first mobile driving mechanism which is arranged on the said flatness detecting table and is used for driving the said first mobile base to move transversely, wherein the two transverse flatness detecting assemblies are connected with the said first mobile base.

6. The automatic production line for conductive tape in accordance with claim 4, which is characterized in that the said longitudinal flatness detecting mechanism comprises two oppositely arranged longitudinal flatness detecting assemblies, a second mobile base which is slidably arranged on the said flatness detecting table and a second mobile driving mechanism which is arranged on the said flatness detecting table and is used for driving the said second mobile base to move transversely, wherein the two longitudinal flatness detecting assemblies are connected with the said second mobile base.

7. The automatic production line for conductive tape in accordance with claim 4, which is characterized in that the said flatness detecting device also comprises an air-blowing dust remover and a second guide roller set respectively arranged on the flatness detecting table, wherein the said air-blowing dust remover is located on one side at the discharge end of the conductor pulling device and the said second guide roller set is located on one side at the feed end of the said ultrasonic cleaning device.

8. The automatic production line for conductive tape in accordance with claim 7, which is characterized in that the said air-blowing dust remover is provided with a passage slot in the axial direction, and the said air-blowing dust remover is provided with several air-blowing passages in the radial direction leading to the passage slot.

9. The automatic production line for conductive tape in accordance with claim 1, which is characterized in that the said abnormality marking device comprises a base body, two guide assemblies, an upper lifting base, a lower lifting base, an upper indenting wheel, a lower indenting wheel, two marking pens and a marking drive mechanism, wherein the said upper indenting wheel is arranged oppositely to the said lower indenting wheel; the said guide assemblies are arranged in the base body; both the said upper lifting base and the lower lifting base are arranged in the base body; the said marking drive mechanism is used for driving the upper lifting base and the lower lifting base to approach or leave each other; the said marking pens are arranged on the upper lifting base and the lower lifting base respectively.

10. A manufacturing method for conductive tape, which is characterized in that it comprises the following steps:
A. The said conductor releasing device releases the conductors;
B. The said conduct pulling device pulls the conductors to move;
C. The said conduct straightening device straightens the moving conductors;
D. The flatness detecting device detects the flatness of the straightened conductors;
E. The said ultrasonic cleaning device cleans the flatness-tested conductors ultrasonically;
F. The said conductor heating device heats the ultrasonically cleaned conductors;
G. The encapsulating extruder encapsulates the heated conductors to form the conductive tape and the wire-rod pulling device pulls the conductive tape to move;
H. When the conductive tape is moving, the said diameter measuring gauge measures the diameter of the conductive tape, the said cooling device cools the conductive tape, the said code spraying device performs the code spraying treatment of the conductive tape, the said ultrasonic wall thickness detecting device measures the encapsulation thickness of the conductive tape, the said appearance detecting device detects the appearance quality of the conductive tape, the said withstand voltage detecting device detects the withstand voltage of the conductive tape, the said abnormality marking device marks the conductive tape which is abnormal upon the withstand voltage test, the said meter measuring device calculates the length of the conductive tape and the said drying device dries the conductive tape.
I. The said wire take-up device winds up the conductive tape.
